(19) United States
(12) Patent Application Publication
(10) Pub. No.: US 2021/0331667 A1
(43) Pub. Date: Oct. 28, 2021

(54) ROAD-TRAFFIC WARNING SYSTEM FOR INCREASING USER SAFETY

(71) Applicant: Yan Aduardovich FILYAROVSKII, Moscow (RU)

(72) Inventor: Yan Aduardovich FILYAROVSKII, Moscow (RU)

(21) Appl. No.: 16/639,688

(22) PCT Filed: Jan. 18, 2019
(86) PCT No.: PCT/RU2019/000027

§ 371 Date: Feb. 17, 2020

(30) Foreign Application Priority Data
Apr. 20, 2018 (RU) 2018114736

(51) Int. Cl. B60W 30/08; B60W 50/14

(52) U.S. Cl. CPC B60W 30/08; B60W 2050/146; B60W 50/14

(57) ABSTRACT

The claimed group of inventions relates to protective clothing with luminous safety means, and also to visual warning devices mounted on vehicles to indicate the dimensions of the vehicles or of parts thereof and to supply warning lights for other vehicles, and can be used for supplying warning lights on kit for special services and children's clothing. The invention comprises luminous elements which replicate signals of standard visual warning devices of a vehicle, wherein the elements are equipped with fastening devices for installation/fastening to, and removal from, elements of kit for a driver and elements of transport vehicles, wherein the power supply and control of the elements is carried out from unit 2 (a device for controlling the luminous elements) which receives control signals from unit 1, which is fitted into the electrical system of warning lights of body-free transport vehicles.

### CROSS-REFERENCE TO RELATED APPLICATION

The present patent application is a National stage application for the PCT application PCT/RU2019/000027 filed on Jan. 18, 2019 which claims priority to Russian patent application RU2018114736 filed Apr. 20, 2018, all of which fully incorporated herein by reference.

### FIELD OF INVENTION

The claimed group of inventions relates to protective clothing with luminous safety means, as well as to optical signaling devices installed on vehicles to indicate the dimensions of the vehicles or vehicle parts and to provide light signals to other vehicles, and is applicable to provide the light signals on special-service equipment and children's clothing.

### BACKGROUND

All existing and ongoing projects (see, for example, https://www.horzabike.ru/single-post/2016/11/14/% D0% A3% D0% BC % D0% BD % D1%8B % D0% B9-% D0% B2% D0% B5% D0% BB % D0% BE % D1%81% D0% B8% D0% BF % D0% B5% D0% B4% D0% BD % D1%8B % D0% B9-% D1%88% D0% BB % D0% B5% D0% BC-Lumos---% D1%84% D0% B0% D1%80% D1%8B-% D0% BF % D0% BE % D0% B2% D0% BE % D1%80% D0% BE % D1%82% D0% BD % D0% B8% D0% BA % D0% B8-% D1%81% D1%82% D0% BE % D0% BF-% D1%81% D0% B8% D0% B3% D0% BD % D0% B0% D0% BB-% D0% B8-% D0% BC % D0% BD % D0% BE % D0% B3% D0% BE % D0% B5-% D0% B4% D1%80% D1%83% D0% B3% D0% BE % D0% B5) in other countries, including the USA, France and China, have a large number of technological errors, thereby making them impossible and inconvenient to use. The object of the claimed group of inventions is to eliminate the drawbacks of the existing and ongoing projects.

### SUMMARY

The technical result of the claimed group of inventions is to extend functionalities, increase traffic safety for users of bodyless vehicles, provide improved visibility of bodyless vehicle drivers and children on the road, as well as to provide child and driver protection, prevent road traffic accidents, place special-service markings on equipment (STSI, RosAvtoDor, RZD, EMERCOM, Miners, Energy Services, Builders, any other special services, etc.), and ensure an improved efficiency factor of safety measures when working in hazardous locations.

### DETAILED DESCRIPTION OF THE PREFERRED EMBODIMENT

The above-posed problem is solved and the technical result is achieved by means of the claimed road transport signaling system for enhancing safety for users of bodyless vehicles and/or vehicles that do not have conventional signaling devices, the system including luminous elements that duplicate signals of conventional optical signaling devices of a vehicle, wherein a device for providing controlled optical signals comprises light indicators: left and right turn signals, combined stop signal, parking lights, running lights, flexible neon light, wherein the light indicators are equipped with fasteners for mounting/fastening and dismounting the light indicators on and from items of pilot equipment and vehicle parts, and wherein Unit 2 is configured to power and control the light indicators. Unit 2 is powered by battery cells, batteries (AA, AAA, etc.), but meanwhile, its operation and/or charging from solar cell modules is also possible. The solar cell modules may be mounted in that place where they are easily accommodated—for example, on the pilot equipment or a backpack. The light indicators may be made on the basis of incandescent lamps, light emitting diodes (LEDs), light guides, neon lamps, LED matrices and matrices of light emitting devices, flexible screens, and are equipped with special fasteners for mounting/fastening and dismounting the light indicators on and from the items of any special equipment, clothing, helmets, backpacks, bags, motorcycle elements, a scooter, quadricycle, tricycle, motodrone/Hoversurf (flying motorcycle) and other bodyless vehicles, including waterborne vehicles, etc. Unit 1 includes a device (transmitter) for short-range data transmission via radio channels and/or other wireless signal or data transmission channels (transmitted data may be digital messages or analog signals coming from a data source, digitized into a bit stream using pulse-code modulation (PCM) or more advanced coding schemes for the data source (analog-to-digital conversion and data compression). Each unit is provided with its own individual code hardware-written in a device circuit. The data source/signal transmitter is coded and decoded by a codec/programmer or other coding means. At the same time, electronic or analog filters and electrical surge and interference protection systems are installed in each unit, since an electrical system of, for example, a motorcycle is very unstable and operates often intermittently, which is detrimental to fine-tuned devices. Voltage surge suppression is achieved by using voltage stabilizers (for example, stabilizer 7805) in power and signal pickup circuits and is intended for the operational stability of a wireless transmitter circuit. These circuits do not have a noticeable effect on a motorcycle circuit.

Unit 1 is installed in an electrical light signaling system of the motorcycle (usually in the electrical isolation of a tail lamp), scooter, quadricycle, tricycle and other bodyless vehicles. For waterborne and airborne vehicles, it is possible to work with a gyroscope (either built-in or via an application on a smartphone). The device is powered by the vehicle or its own battery or replaceable batteries. Unit 1.2 includes a device for remote manual control and short-range data transmission via radio channels and/or other wireless signal/data transmission channels (transmitted data may be digital messages or analog signals coming from a data source, digitized into a bit stream, using the pulse-code modulation (PCM) or more advanced coding schemes for the data source (the analog-to-digital conversion and data compression), and made as a button-, voice- or touch-controlled device, wherein Unit 1.2 is powered by the vehicle or by its own battery or replaceable batteries.

Unit 2 (2.1) includes a receiving device for short-range data transmission via radio channels (a control device for light elements), each unit being provided with its own individual code hardware-written in the device circuit. Each set of equipment (Unit 1-Unit 2) is interconnected and operates with each other in the same frequency range. Unit 2 (2.1) is equipped with: an electronic device for “learning” a unique code outgoing from/belonging to Unit 1, thereby providing increased use and distribution of the devices and avoiding the need to contact a manufacturer to encode a certain set; a battery compartment; a battery charging system; a control unit and a unit for synchronously repeating, by its own light elements, the light signals of the bodyless vehicles; a convector for controlling neon light elements and controlling a geolocation unit. An electronic part of Unit 2 (2.1) is provided with a system for reducing energy consumption without brightness loss of the light elements. The GPS geolocation unit (GSM/GPRS tag or SIM card) includes a beacon for tracking a pilot or vehicle, the GPS unit transmitting a SOS signal to phone numbers predefined by a user, in order to automatically notify when a subject is in danger. In the meantime, it is possible to track movements of the pilot in real time by coordinating data from a GPS sensor with maps. Unit 3 includes a device with a display for indicating a power level of the battery of the receiving device, current time, air temperature, an operation indicator of the GPS tag. A collision sensor and a GSM tag are mounted in Unit 3, the GSM tag showing where the pilot is and transmitting, in case of an accident, the SOS signal and turning on emergency lighting on the equipment. Unit 3 is further equipped with its battery and its charging system, the unit being further equipped with fasteners for its mounting/fastening on and dismounting from the items of the equipment and the elements of the bodyless vehicles or a pilot body. It is also possible to use a lighting sensor, which may be mounted in Unit 3 or installed on the equipment. The lighting sensor is triggered when lighting changes to poor lighting, and the lighting sensor causes the parking lights and/or running lights to be turned on if the parking lights and/or running lights are turned off at the instant of said changes in lighting. The lighting sensor automatically turns off the parking lights and/or running lights when the amount of the lighting changes inversely to good lightning.

Unit 3 is also provided with an emergency collision/rollover/fall sensor, which is triggered by a force of impact and/or by means of a wire rope with a safety pin, the safety pin being attached to motorcycle handlebars and on a pilot wrist. When the sensor is triggered, a bright emergency stop light/SOS signal (for example, a strobe) is turned on to provide visibility and detection of the pilot, the SOS signal being transmitted via the GSM tag, and an engine of the bodyless vehicle is configured, in case of emergency, to be shut down/turned off/cut off if the collision sensor is triggered and the safety pin is taken out using a safety cord. What is also provided are a button for turning on/off the system, which is mounted on the equipment, and a set of connecting wires, adapters and mounts for mounting and dismounting the road transport signaling system.

When using such a bodyless vehicle as a motorcycle, Unit 1 is a device transmitting current motorcycle signals via radio communications or by wire, is provided with a circuit for receiving/transmitting incoming signals from the motorcycle to Unit 2/a radio receiver (receiving device for short-range data transmission over radio channels in state-authorized frequency ranges) or through a wired system.

Unit 1 is equipped, at the output of an electronic transceiver circuit, with wires that are connected in the tail lamp compartment of the motorcycle based on a circuit appended to the unit. Accordingly, power is supplied to a power wire (Unit 1 is powered when the motorcycle mode is on (ignition ON), to left turn and right turn signal wires, as well as to stop signal wires (see FIG. 1). Unit 1 may also be connected to the vehicle in any other place suitable for its mounting according to the existing circuit.

When the motorcycle ignition is in the ON position, power is supplied to the input of a transmission line (wireless, consisting of a transmitter and receiver, or wired (without a radio transmitting device)), for which reason the transmission line turns on automatically. Next, a current state signal of signal lights is fed from the motorcycle circuit, and the transmission line transmits the signal to the control device for the signal elements (Unit 2), which is turned on by a remote button mounted on the equipment. According to the incoming motorcycle signals, the control device for the signal elements synchronously turns on, turns off or changes the brightness of its own corresponding light elements. The light elements responsible for the parking lights or running lights are constantly on and are powered by Unit 2.

When using such a bodyless vehicle as a bicycle and other vehicles not equipped with their own electrical signaling devices, the signaling set of Unit 1 is made as a device/remote control for manual data transmission. Unit 1 is fastened mainly on a vehicle steering wheel, but its holding or fastening in the pilot hand or on the pilot equipment is also possible. The device is powered by the vehicle or its own battery or replaceable batteries. An electronic chip having programmed options for glowing the light elements is also installed here, the electronic chip being also configured to control the light elements.

Unit 2 and the light elements/Signaling set mounted on the equipment, backpack or vehicle elements (installed anywhere at the request of the user) are switched by the user to the ON position by using the remote button of the signaling set, and the remote button is also used to select the operational mode of the signaling set.

Next, the user starts moving/an operational process.

A set of lights operates in the following several modes:

1. The parking/running lights and movement signals (stop signal, right and left turn signals).

2. The parking/running lights in a constant lighting mode

3. The parking/running lights in a flickering mode

The operational modes of the signaling set are selected by means of switching via the remote control (Unit 1).

Children's signaling sets, their light elements, may be made in any form, using children's symbols, animals or heroes of children's fairy tales, movies, etc. This set uses modified Unit 2—it does not use a radio receiving system but has an electronic chip with programmed options for glowing the light elements, with the electronic chip being configured to control the light elements. The user switches Unit 2 to the ON position by using the remote button of the set, with the remote button being also configured to select the operational mode of the set.

Next, the user starts using the set at his/her discretion.

The same operational principle is applied in the sets of the road transport signaling system for special services. In this case, the same light elements are not made in the children's stylistics, and the set uses different programming for providing the light signals—for each special service these programs are written individually.

All connecting cables, adapters, control buttons and housings of Unit 1, Unit 2, Unit 3 are coated with moisture-resistant protective materials.

### BRIEF DESCRIPTION OF THE DRAWINGS

The accompanying figures show the following:

FIG. 1—a connection diagram

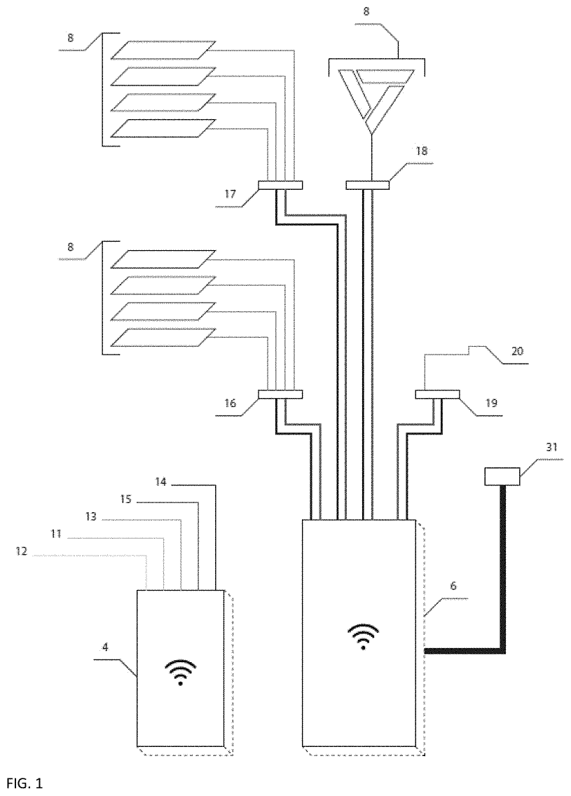

FIG. 2—a wireless connection diagram

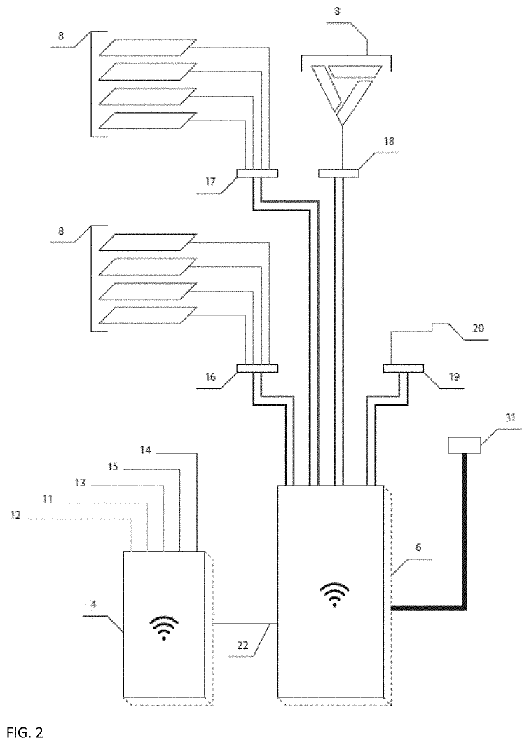

FIG. 3—a diagram for a bicycle

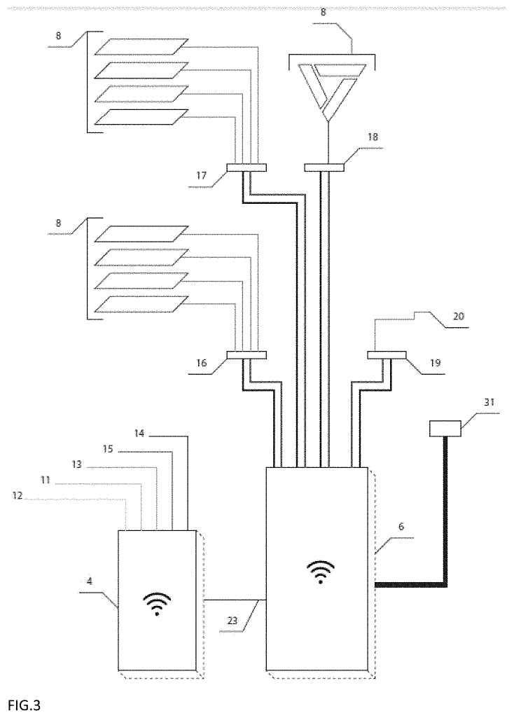

FIG. 4—a connection diagram for children and special services

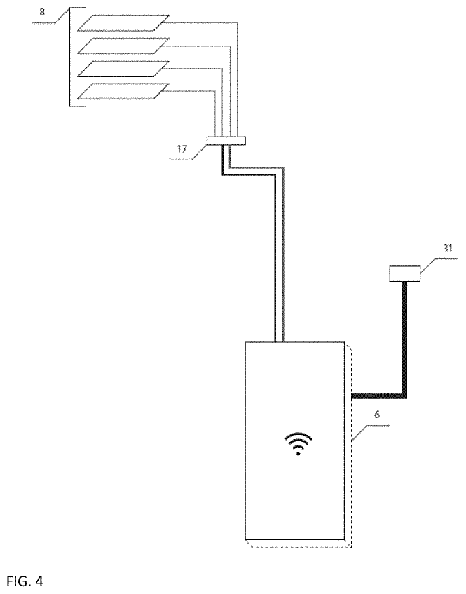

FIG. 5—a Unit 1-to-vehicle connection diagram

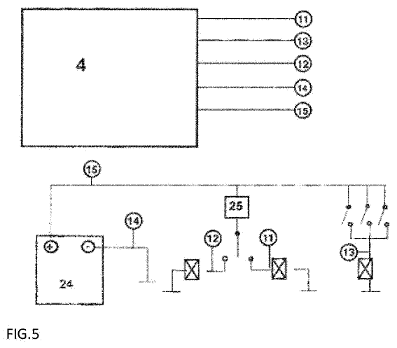

FIG. 6—a wired diagram for the bicycle

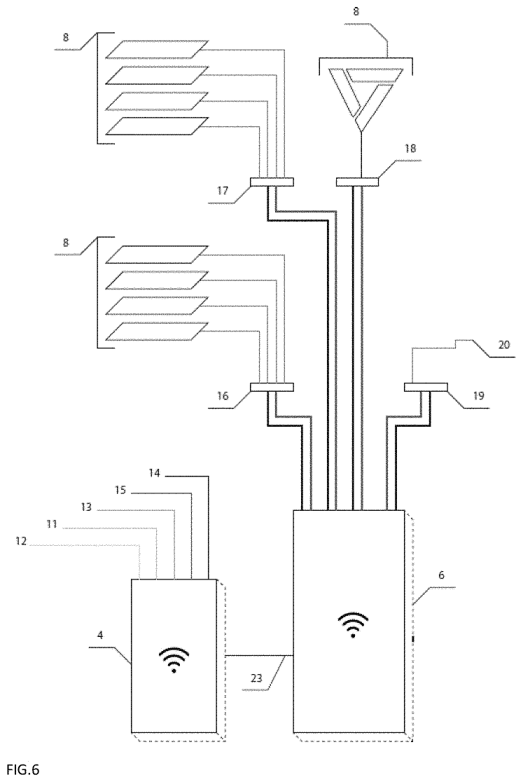

FIG. 7—a wired diagram

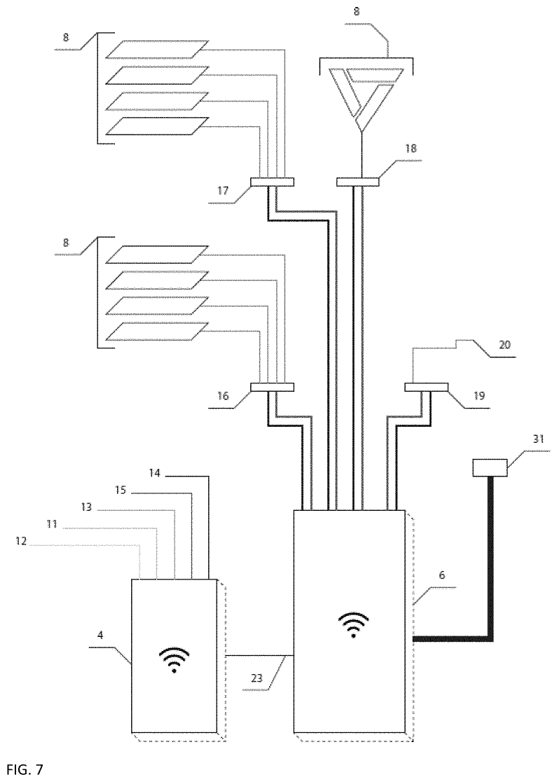

FIG. 8—a diagram with Unit 3

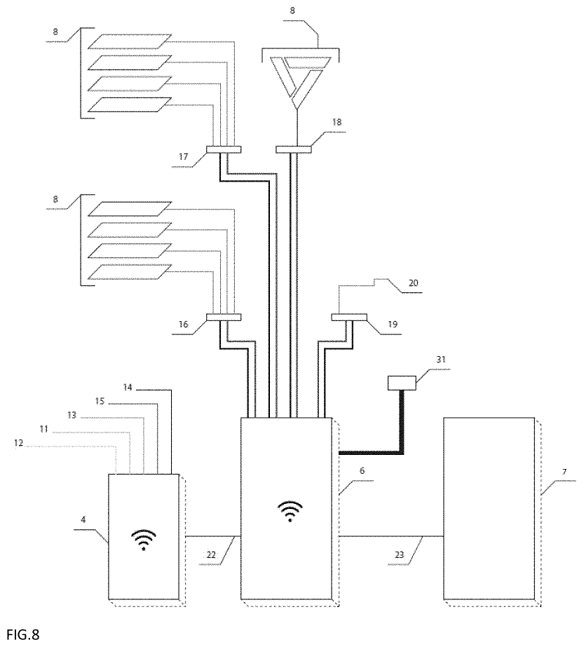

FIG. 9—a diagram with Unit 3

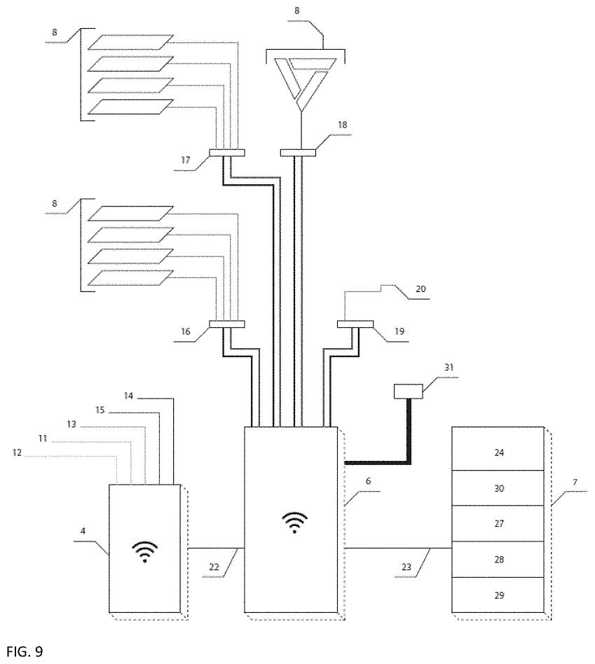

FIG. 10—shapes and types of light-emitting elements

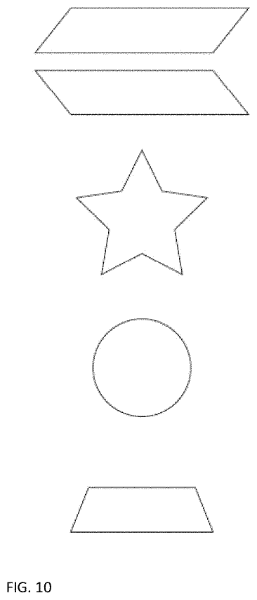

### THE LIST OF REFERENCES

Ref 1—a vehicle equipped with light signals
Ref 2—a vehicle not equipped with light signals
Ref 3—vehicle lighting devices

### Ref 4—Unit 1

### Ref 5—Unit—1.1

### Ref 6—Unit 2

### Ref 7—Unit 3

Ref 8—light-emitting elements
Ref 9—shapes and types of the light-emitting elements

### Ref 10—a GSM tag

Ref 11—a right turn
Ref 12—a left turn
Ref 13—a stop signal
Ref 14—ground (electrical grounding)
Ref 15—power 12 V+
Ref 16—a connection line for left-turn indicators
Ref 17—a connection line for right-turn indicators
Ref 18—a connection line for the stop signal
Ref 19—a connection line for parking and running lights
Ref. 20—a connection line for neon lights
Ref. 21—a Unit 1-to-Unit 2 connection line
Ref. 22—wireless data transmission
Ref. 23—wired data transmission
Ref. 24—a power supply/battery
Ref. 25—a light signal relay
Ref. 26—equipment items
Ref. 27—a display of Unit 3
Ref. 28—a lighting sensor
Ref. 29—a collision sensor
Ref. 30—a connection line for the signal lights (children's equipment and special-service equipment)
Ref 31—a remote control button

What is claimed is:

1. A road transport signaling system for enhancing safety for drivers/users of bodyless vehicles, comprising luminous elements that duplicate signals of conventional optical signaling devices of a vehicle, characterized in that a device for providing controlled optical signals comprises:
light indicators: left and right turn signals, combined stop signal, parking lights, running lights, flexible neon light, wherein the light indicators are equipped with fasteners for mounting/fastening and dismounting the light indicators on and from items of driver equipment and vehicle parts, and wherein Unit 2 is configured to power and control the light indicators, Unit 2 being powered by battery cells, batteries;
Unit 1 including a device (transmitter) for short-range data transmission via radio channels, wherein Unit 1 is provided with its own individual code hardware-written in a device circuit, and each Unit 1 is equipped with electronic filters and electrical surge and interference protection systems, and Unit 1 is installed in an electrical light signaling system of the bodyless vehicles;
Unit 1.2 including a device for remote manual control and short-range data transmission via radio channels, wherein Unit 1.2 is provided with its own individual code hardware-written in the device circuit, and Unit 1.2 is made as a button-, voice- or touch-controlled device, wherein Unit 1.2 is powered by the vehicle or its own battery or replaceable batteries;
Unit 2 (2.1) (a control device for light elements) including a receiving device (receiver) for short-range data transmission from Unit 1 via radio channels, each Unit being provided with its own individual code hardware-written in the device circuit;
wherein each set of equipment (Unit 1-Unit 2) is interconnected and operates with each other in the same frequency range;
wherein Unit 2 (2.1) is equipped with an electronic device for “learning” a unique code outgoing from/belonging to Unit 1, a battery compartment, a battery charging system, a control unit and a unit for synchronously repeating, by its own light elements, the light signals of the bodyless vehicles, a convector for controlling neon light elements and controlling a geolocation unit,
wherein an electronic part of Unit 2 (2.1) is provided with a system for reducing energy consumption without brightness loss of the light elements;
a GPS geolocation unit (GSM/GPRS tag or SIM card) including a beacon for tracking a pilot or the vehicle, the GPS unit transmitting a SOS signal to phone numbers predefined by a user, in order to automatically notify when a subject is in danger, wherein it is possible to track movements of the pilot in real time by coordinating/combining data from a GPS sensor with maps;
Unit 3 including a device with a display for indicating and showing a power level of the battery of the receiving device, current time, air temperature, an operation indicator of the GPS tag, wherein a collision sensor and a GSM tag are mounted therein, the GSM tag showing where the pilot is and transmitting, in case of an accident, the SOS signal and turning on emergency lighting on the equipment, wherein the unit is further equipped with its battery and its charging system, the unit being further equipped with fasteners for its mounting/fastening on and dismounting from the items of the equipment and the parts of the bodyless vehicles;
a lighting sensor, which may be mounted in Unit 3 or installed on the equipment, wherein the lighting sensor is triggered in case of changes in lighting, and the lighting sensor causes the parking lights and/or running lights to be turned on if the parking lights and/or running lights are turned off at the instant of said changes in lighting, and wherein the sensor automatically turns off the parking lights and/or running lights if a lighting amount changes inversely;
an emergency collision/rollover/fall sensor, which is triggered by a force of impact and/or by means of a wire rope with a safety pin, the safety pin being attached to motorcycle handlebars and on a pilot wrist, wherein when the sensor is triggered, a bright SOS emergency stop light signal (for example, a strobe) is turned on to provide visual detection of the pilot, the SOS signal being transmitted via the GSM tag, and wherein an engine of the bodyless vehicle is configured, in case of emergency, to be shut down/turned off/cut off if the collision sensor is triggered and the safety pin is taken out using a safety cord;
a button/device for turning on/off the system, which is mounted on the equipment or installed in Unit 3;
a set of connecting wires, adapters and mounts.

2. The road transport signaling system for enhancing safety for the users of a child's age group according to claim 1, wherein, in Unit 2, an electronic chip is installed instead of a radio receiving system, the electronic chip having programmed options for glowing its own light elements placed on children's clothing and/or backpack, the electronic chip being used to control the light elements in such a way that the user turns on Unit 2 by using the remote button of the set, the remote button being used to select an operational mode of the set.

3. A method of operating a road transport signaling system to enhance safety for users of bodyless vehicles and special services, comprising supplying power to an input of a transmission line (wireless, consisting of a transmitter and receiver, or wired (without a radio transmitting device)) when turning on an ignition of a bodyless vehicle and automatically triggering the system, wherein a current state signal of signal lights is next fed from an electric/electronic circuit of the bodyless vehicle, and the transmission line transmits the signal to a control device for signal elements (Unit 2), which is turned on by a remote button installed on equipment or on Unit 3, and wherein according to the incoming signals of the vehicle, the control device for the signal elements synchronously turns on, turns off or changes a brightness of corresponding light elements, the light elements responsible for parking/running lights being constantly on and powered by Unit 2.
